(19) United States
(12) Patent Application Publication
(10) Pub. No.: US 2007/0014628 A1
(43) Pub. Date: Jan. 18, 2007

(54) Clamp

(76) Inventors: Simon Klippel, Knaresborough, North Yorkshire (GB); Neil F. Gill, Shipley, West Yorkshire (GB)

Correspondence Address: TYCO ENGINEERED PRODUCTS & SERVICES;ATTN: INTELLECTUAL PROPERTY LAW DEPARTMENT, 9 ROSZEL ROAD, PRINCETON, NJ, 08540, US

(21) Appl. No.: 10/578,705

(22) PCT Filed: Nov. 28, 2003
(86) PCT No.: PCT/GB03/05184

§ 371 Date: May 10, 2006

(30) Foreign Application Priority Data
Nov. 29, 2002 (GB) 0227816.6
May 28, 2003 (GB) 0312125.8

(51) Int. Cl. B25G 3/18

(52) U.S. Cl. 403/321

(57) ABSTRACT

A clamp comprises: a first jaw (2) and a second jaw (3) having opposing contact surfaces (8, 9) which are relatively substantially linearly displaceable between a position of minimum separation and a position of maximum separation, wherein in use the opposing contact surfaces (8, 9) contact the lower surface and upper surface respectively of a structural element, wherein the first jaw (2) incorporates a first aperture remote from the contact surface and adapted to receive a suspension element or fastener; one or more means for guiding the first jaw (2) and the second jaw (3) during relative substantially linear displacement such as to substantially prevent relative non-linear displacement of the opposing contact surfaces (8, 9); and means for delimiting the substantially linear displacement of the opposing contact surfaces (8, 9) of the first jaw (2) and second jaw (3) to the position of maximum separation.

The present invention relates to a clamp for suspending a utility component from a structural element (such as a beam) comprising first and second jaws having opposing contact surfaces which are relatively substantially linearly displaceable.

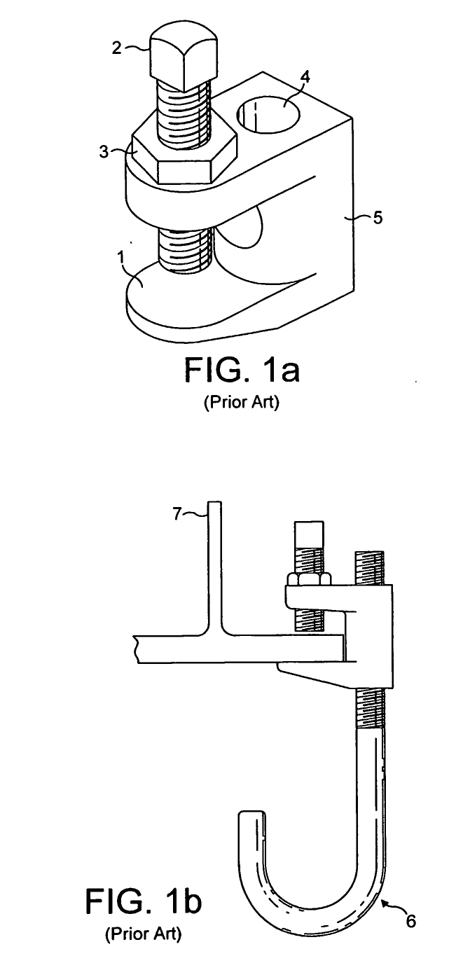

A conventional beam or flange clamp for suspending a utility component from a structural element such as a beam comprises a main body which is drilled or tapped at its rear portion in order to secure a drop rod outside and separate to the clamping region by means of rivets or bolts. The operation of this clamp is illustrated schematically in FIGS. 1a and 1b. A beam (or flange thereof) 7 is inserted in jaws 1 and clamped directly by appropriate manipulation of cup point set screw 2 and locking nut 3. A rear portion of the main body 5 is provided with a tapped or clear hole 4 for securing a threaded or non-threaded drop rod respectively (not shown in FIG. 1a). FIG. 1b illustrates the use of the clamp with a J bolt 6 passing through hole 5 for suspension of (for example) pipework.

The load bearing characteristics of the conventional clamp are largely unsatisfactory. For example, a utility component suspended from the drop rod exerts a significant disruptive moment about the separate clamping region. Moreover for use on tapered beams, it is imperative that the set screw bites into the tapered face of the flange (rather than the horizontal face) otherwise installation may fail.

WO-A-00/52343 (Tyco European Metal Framing Limited) discloses a rigid clamp comprising two C-shaped plates whose respective ends are connected by a boss. Each boss defines a path for receiving a drop rod so that when the clamp is located on the beam, the drop rod is inserted into the lower boss and is secured to the underside of the beam. Thus the drop rod becomes a load bearing element acting directly at the clamping region.

The present invention seeks to improve clamps by incorporating first and second jaws having opposing contact surfaces which are relatively substantially linearly displaceable causing them to close securely in a substantially parallel manner onto structural elements of varying thickness. More particularly, the present invention relates to a clamp incorporating first and second jaws having opposing contact surfaces which are relatively substantially linearly displaceable and which exhibits high load bearing capabilities.

Thus viewed from one aspect the present invention provides a clamp comprising:

a first jaw and a second jaw having opposing contact surfaces which are relatively substantially linearly displaceable between a position of minimum separation and a position of maximum separation, wherein in use the opposing contact surfaces contact the lower surface and upper surface respectively of a structural element, wherein the first jaw incorporates a first aperture remote from the contact surface and adapted to receive a suspension element or fastener;

one or more means for guiding the first jaw and the second jaw during relative substantially linear displacement such as to substantially prevent relative non-linear displacement of the opposing contact surfaces; and

means for delimiting the substantially linear displacement of the opposing contact surfaces of the first jaw and second jaw to the position of maximum separation.

The relative substantially linear displaceability of the first and second jaw advantageously makes the clamp suitable for high load uses.

The structural element is typically a beam (or a flange thereof) for which the clamp may be able to withstand a load of 1000 kg (or more).

Typically the suspension element is a drop rod but numerous other suspension elements (such as J-bolts, set screws, wire elements) may be used. From the suspension element may be suspended utility components such as fixing brackets, pipe supports, fire protection equipment, cable trays, cables, wires, electrical conduits, heating equipment, ventilating equipment or air conditioning equipment. Equally the clamp of the invention may be furnished with one or more piercings, apertures, slots and tabs either for suspending directly any of the previous utility components or for suspending indirectly from conventional means any of the above-mentioned utility components (but especially electrical cables, pipes and wires from cable/wire clamps, clips and ties or hoses from snapper hose clamps).

Preferably the first jaw comprises a first reentrant body and the second jaw comprises a second reentrant body. Typically the first reentrant body is nested at least partially within the second reentrant body.

Preferably the first reentrant body is symmetrically nested at least partially within the second reentrant body. For example, the first reentrant body has a smaller overall dimension than the second reentrant body to enable it to be symmetrically nested at least partially within the second reentrant body. Generally the depth of the second reentrant body determines the strength of this embodiment and it is preferred that the second reentrant body is deeper than the first reentrant body. It is also advantageous for the first reentrant body to be composed of a material which is sufficiently springy for it to be snugly symmetrically nested at least partially within the second reentrant body. Typically for this purpose, the first reentrant body is composed of a material which is thinner than the material of which the second reentrant body is composed.

Alternatively preferably the first reentrant body is asymmetrically nested at least partially within the second reentrant body. The asymmetrically nested arrangement permits the first and second jaw to be manufactured with a substantially identical profile with advantageous cost savings.

Typically each reentrant body has a base between substantially parallel opposed side walls (which may be the same or different), a leading edge (that of the first and second reentrant body together defining a mouth) and a trailing edge (that of the first and second reentrant body together defining an open rear end). Preferably the contact surface of the (eg the first) or each (ie the first and second) reentrant body has an extended inner edge which in use abuts a surface (eg the leading edge) of the structural element. This advantageously assists installation of the clamp by permitting the installer to push the extended inner edge against the leading edge of the structural element and steady the clamp for securement. The extended inner edge may adopt any shape but generally speaking will adopt a shape to conform to the leading edge of the beam. Since in most situations, the leading edge of the beam will be non-curved (eg square), the extended inner edge will be substantially perpendicular to the contact surface (and preferably extend substantially parallel to the direction of linear displacement).

Preferably the first jaw comprises a first substantially U-shaped channel member and the second jaw comprises a second substantially U-shaped channel member. The leading edge of the second substantially U-shaped channel member may have a cut-away nose portion in its upper part. The leading edge of the first substantially U-shaped channel member may be chamfered or rounded into a “chin” in its lower part. Preferably the outer edge of the contact surface of either or (preferably) both of the first and second jaw is tapered or radiussed. This advantageously provides a camming surface (or camming surfaces) to assist the installer to manually bring the contact surfaces into contact with the upper and lower surface of the structural element (eg by locating the clamp adjacent the leading edge of the structural element and applying firm pressure to assist a “snap fit” using one hand). Where the outer edge of the contact surface of both of the first and second jaw is tapered or radiussed, the clamp of the invention may be advantageously secured to tapered upper and lower surfaces of the structural element. Where appropriate one or more faces of the first and/or second jaw may be ribbed or otherwise provided with strengthening means.

The means for delimiting the substantially linear displacement of the opposing contact surfaces of the first jaw and second jaw to the position of maximum separation is generally located between the extended inner edge of the contact surface of the first and second jaw and the trailing edge of the first and second jaw. The means for delimiting the substantially linear displacement of the opposing contact surfaces of the first jaw and second jaw to the position of maximum separation and one of the means for guiding the first jaw and the second jaw during relative substantially linear displacement may be the same.

The one or more means for guiding the first jaw and the second jaw during relative substantially linear displacement are generally located at or between the extended inner edge of the contact surface of the first and second jaw and the trailing edge of the first and second jaw. In this location, they serve to arrest rotational moments (ie rocking) created as a reaction to clamping forces as the clamp is tightened.

Preferably a first means for guiding the first jaw and the second jaw during relative substantially linear displacement is located at or near to the extended inner edge of the contact surface of the first and second jaw. Particularly preferably a second means for guiding the first jaw and the second jaw during relative substantially linear displacement is located at or near to the trailing edge of the first and second jaw. More preferably a first means for guiding the first jaw and the second jaw during relative substantially linear displacement is located at or near to the extended inner edge of the contact surface of the first and second jaw, a second means for guiding the first jaw and the second jaw during relative substantially linear displacement is located at or near to the trailing edge of the first and second jaw and a third means for guiding the first jaw and the second jaw during relative substantially linear displacement is located between the first and second means for guiding the first jaw and the second jaw during relative substantially linear displacement. This embodiment is particularly effective in preventing relative non-linear displacement (eg rocking) of the first and second jaw.

One or more of the means for guiding the first jaw and the second jaw during relative substantially linear displacement comprises:

male and female portions on the first jaw and second jaw slidably engageable in a direction parallel to the direction of linear displacement.

Preferably the male and female portions comprise:

either (1) at least a part of the trailing edge of the first reentrant body folded over at least a part of the trailing edge of the second reentrant body or (2) at least a part of the trailing edge of the second reentrant body folded over at least a part of the trailing edge of the first reentrant body. Particularly preferably at least a part of the trailing edge of the second reentrant body is folded over at least a part of the trailing edge of the first reentrant body. More preferably twin parts of the trailing edge of the second reentrant body extending parallel to the direction of linear displacement are folded over twin parts of the trailing edge of the first reentrant body extending parallel to the direction of linear displacement.

The extent to which the twin parts of the trailing edge of the second reentrant body fold over twin parts of the trailing edge of the first reentrant body may vary the performance of the clamp. Generally it is preferred that the extent to which the twin parts of the trailing edge of the second reentrant body fold over the twin parts of the trailing edge of the first reentrant body is large (eg such that the twin parts of the trailing edge of the second reentrant body are (or are almost) touching). Preferably the extent to which the twin parts of the trailing edge of the second reentrant body fold over the twin parts of the trailing edge of the first reentrant body is such that the twin parts of the trailing edge of the second reentrant body are overbent (eg inwardly overbent) which advantageously gives a locking effect.

Preferably the male and female portions comprise:

one or more elongate discontinuities extending parallel to the direction of linear displacement in the side of the second jaw slidably engageable with one or more elongate discontinuities extending parallel to the direction of linear displacement in the side of the first jaw. Particularly preferably the male and female portions comprise: first and second elongate discontinuities extending parallel to the direction of linear displacement in the opposing sides of the second jaw slidably engageable with first and second elongate discontinuities extending parallel to the direction of linear displacement in the opposing sides of the second jaw.

Each elongate discontinuity may be an elongate depression in the exterior face of the side of the jaw. Preferred is a substantially V-shaped elongate depression.

The male and female portions may be one or more (preferably two) tabs slidably engageable with one or more (preferably two) elongate surfaces, slots or apertures extending parallel to the direction of linear displacement.

In a first preferred embodiment, the tab is inwardly dependent from a side of the second jaw and is slidably engageable with an elongate aperture extending parallel to the direction of linear displacement in a side of the first jaw. Particularly preferably first and second tabs are inwardly dependent from opposing sides of the second jaw and are respectively slidably engageable with first and second elongate apertures extending parallel to the direction of linear displacement in opposing sides of the first jaw. The axis of the or each inwardly dependent tab is typically substantially parallel to the direction of linear displacement.

In the first preferred embodiment, the elongate aperture determines the extent of relative substantially linear displacement of contact surfaces of the first and second jaw (ie acts as the means for delimiting the substantially linear displacement of the opposing contact surfaces of the first jaw and second jaw to the position of maximum separation).

Alternatively in a second preferred embodiment, the tab is inwardly dependent from a side of the second jaw and is slidably engageable with the extended inner edge of the contact surface of the first jaw extending parallel to the direction of linear displacement. Particularly preferably first and second tabs are inwardly dependent from opposing sides of the second jaw and are respectively slidably engageable with first and second portions of the extended inner edge of the contact surface of the first jaw extending parallel to the direction of linear displacement. The axis of the or each inwardly dependent tab is typically perpendicular to the direction of linear displacement.

Alternatively in a third preferred embodiment the tab is inwardly dependent from an edge (eg the edge between the extended inner edge and the trailing edge) of the second jaw and is slidably engageable with an elongate slot extending parallel to the direction of linear displacement in a side of the first jaw. Particularly preferably a first tab is inwardly dependent from an edge (eg the edge between the extended inner edge and the trailing edge) of the second jaw and is slidably engageable with a first elongate slot extending parallel to the direction of linear displacement in a side of the first jaw and a second tab is inwardly dependent from an edge (eg the edge between the extended inner edge and the trailing edge) of the first jaw and is slidably engageable with a second elongate slot extending parallel to the direction of linear displacement in a side of the second jaw. It is preferred for the first and second tab to adopt a T-shaped profile so that the arms of the T extend beyond the edges of the elongate slot to provide a locking effect. Moreover by judicious positioning of the first and second tabs along the edges (eg the edges between the extended inner edge and the trailing edge), it is possible for the tabs to engage the fastener or suspension element to withstand rocking.

In the third preferred embodiment, the elongate slot determines the extent of relative substantially linear displacement of contact surfaces of the first and second jaw (ie acts as the means for delimiting the substantially linear displacement of the opposing contact surfaces of the first jaw and second jaw to the position of maximum separation).

An edge of the first and/or second jaw between the extended inner edge and the trailing edge (eg in any of the first, second or third preferred embodiments but especially the third embodiment) preferably extends inwardly into a flange. By its positioning, the flange is adapted to be clear of the fastener or suspension element in effective use and for this purpose may be radiussed. By its positioning, the flange serves to engage the fastener or suspension element to withstand rocking.

Although the use of tabs and apertures/surfaces is adequate for normal loads, it is preferred for very high loads that one or more of the means for guiding the first jaw and the second jaw during relative substantially linear displacement comprises:

a securing member, wherein either (1) said securing member is secured to the first jaw and is slidably engageable with first and second collinear elongate apertures extending parallel to the direction of linear displacement in opposing sides of the second jaw or (2) said securing member is secured to the second jaw and is slidably engageable with first and second collinear elongate apertures extending parallel to the direction of linear displacement in opposing sides of the first jaw.

Particularly preferably the securing member is secured to the second jaw and is slidably engageable with first and second collinear elongate apertures extending parallel to the direction of linear displacement in opposing sides of the first jaw.

The securing member may (for example) be a rivet passing through the collinear apertures and fixed in a conventional manner (eg passing through a hole in the side of the jaw and secured exteriorly).

In a preferred embodiment, the clamp further comprises:

biassing means for biassing the first jaw and second jaw towards the position of minimum separation. The advantage of the biassing means is that it permits the clamp to be mounted in a “snap fit” action using one hand where it will be held in place until the fastener is fastened to secure the clamp more permanently.

The biassing means may be a resilient biassing means. For example, the resilient biassing means may be a spring such as a compression or tensile spring (eg a coiled or flat spring), an elastomer or damping device. One end of the resilient biassing means may be fastened to one (or a part of one) of the means for guiding the first jaw and the second jaw during relative substantially linear displacement.

Where the securing member is secured to the second jaw and is slidably engageable with first and second collinear elongate apertures extending parallel to the direction of linear displacement in opposing sides of the first jaw, it is preferred that one end of the resilient biassing means is fastened to the securing member and the other to an interior surface of the first jaw (eg the base).

The first jaw may incorporate a first aperture rearwardly or forwardly of the contact surface. Preferably the first jaw incorporates a first aperture rearwardly of the contact surface. In a preferred embodiment, the second jaw incorporates a second aperture substantially collinear with the first aperture, wherein the first and second aperture are adapted to receive the suspension element or fastener.

In use, the clamp of the invention may be secured to the structural element by passing the suspension element or fastener through the first aperture (and optionally the second aperture). The first and second aperture may be tapped or non-tapped to receive a threaded or non-threaded suspension element or fastener as desired.

The (or each) nut may be a standard hexagonal nut. The (or each) nut may be a pressed steel nut (eg in the form of a u-shaped threaded clip which may be slid onto the base of the jaw over the aperture so as to position the thread either internally or externally). The (or each) nut may be a rivetted nut such as a RIVNUT™ (eg a nut with a short tubular collar which may be tightly crimped, deformed or rivetted to attach to the jaw to form a female thread or may be loosely crimped, deformed or rivetted to attach to the jaw but remain rotatable).

Where the aperture itself is threaded, the material at the aperture may be deformed or shaped (eg by punching) to form the threaded portion. However, the aperture may be flow drilled (ie drilled using a special drill bit which generates frictional heat sufficient to render plastic the steel around the aperture so that it flows and deforms into a thin tube which may be tapped to form the threaded portion).

By way of example, the first aperture may be non-tapped and the suspension element or fastener may be fastened by a first hexagonal nut tightened against the exterior surface of the base of the first jaw and (optionally) a second hexagonal nut tightened against the interior surface of the base of the first jaw. Similarly, the second aperture may be non-tapped and the suspension element or fastener may be fastened by a first hexagonal nut tightened against the exterior surface of the base of the second jaw and (optionally) a second hexagonal nut tightened against the interior surface of the base of the second jaw.

By way of a preferred example, the first aperture may be non-tapped and the second aperture may be punched or flow drilled to form the threaded portion or be provided with a nut (eg a pressed steel nut or rivetted nut). The fastener or suspension element passes through the first aperture and engages the second aperture so that subsequent rotation draws together the first and second jaws advantageously without the need for actuating tools such as spanners.

By way of a preferred example, the first aperture may be flow drilled to form the threaded portion or be provided with a tightly crimped rivetted nut and the second aperture may be provided with a loosely crimped, rotatable rivetted nut. The fastener or suspension element rotates through the first aperture and second aperture to the desired height from where the rotatable, rivetted nut may be rotated to draw together the first and second jaw.

The contact surface of the first and second jaw will depend on the utility of the clamp. Where the structural element is a beam, the contact surface of the first jaw and second jaw is generally the surface of its edges (the “gums”). The edges may be rolled or folded to provide an enlarged contact surface in which there is advantageously reduced levels of localised stress.

The whole or a portion of the contact surface of either or both of the first and second jaw may be toothed. For example, the whole or a portion of the contact surface of either or both of the first and second jaw may be provided with a plurality of teeth (eg substantially V-shaped teeth (which may be angled or flattened) or substantially n-shaped teeth). Alternatively the whole of the contact surface of either or both of the first and second jaw may be smooth so as to provide an uninterrupted contact which avoids unsightly indentations on the surface of the structural element. In the embodiment where the first and second jaw are asymmetrically nested, the contact surfaces of the first and second jaw are offset and the clamping effect may be improved by angling or stepping one or more of the teeth to accommodate the offset.

Suitable elongate fasteners are generally threaded fasteners (eg bolts) which are fastened with one or more (eg two) nuts.

The first and second apertures may be any suitable shape such as round, square, pyramidal, ellipsoidal, rectangular and may be slotted. In the embodiment where the first and second jaw are asymmetrically nested, the first and second apertures are ellipsoidal to accommodate the asymmetry.

Typically, the clamp of the invention will be made from mild steel which is optionally electro-zinc plated. More generally, the choice of material and dimensions appropriate for the purpose will be readily apparent to the skilled man.

In use, the first and second jaws of the clamp of the invention may be opened manually to an extent sufficient to capture between the opposing contact surfaces the lower and upper surfaces of a structural element (eg a beam). Where the leading edges of the contact surfaces is radiussed, they may be used as a camming surface to force open the first and second jaws by pressing the mouth of the clamp against the leading edge of the structural element. The clamp may be steadied by bringing the leading edge of the structural element into contact with the extended inner edges of the first and second jaw. From this position, the first and second jaws are closed so that the opposing contact surfaces contact the lower surface and upper surfaces of the structural element. The clamp may be secured using the fastener passing through the aperture(s).

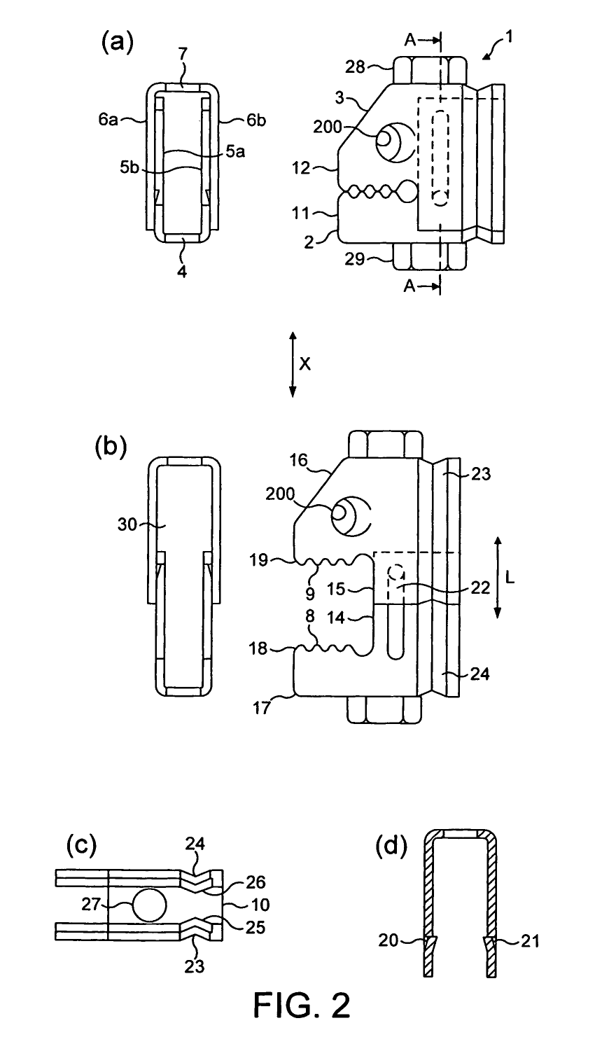

The invention will now be described in a non-limitative sense with reference to accompanying FIGS. 2 to 5 in which:

FIGS. 2a-c illustrates a first embodiment of the clamp of the invention at positions of (a) minimum separation of the jaws (side and end views) and (b) maximum separation of the jaws (side and end views) and in (c) top view and FIG. 2d illustrates an end view of the second jaw in isolation along section AA;

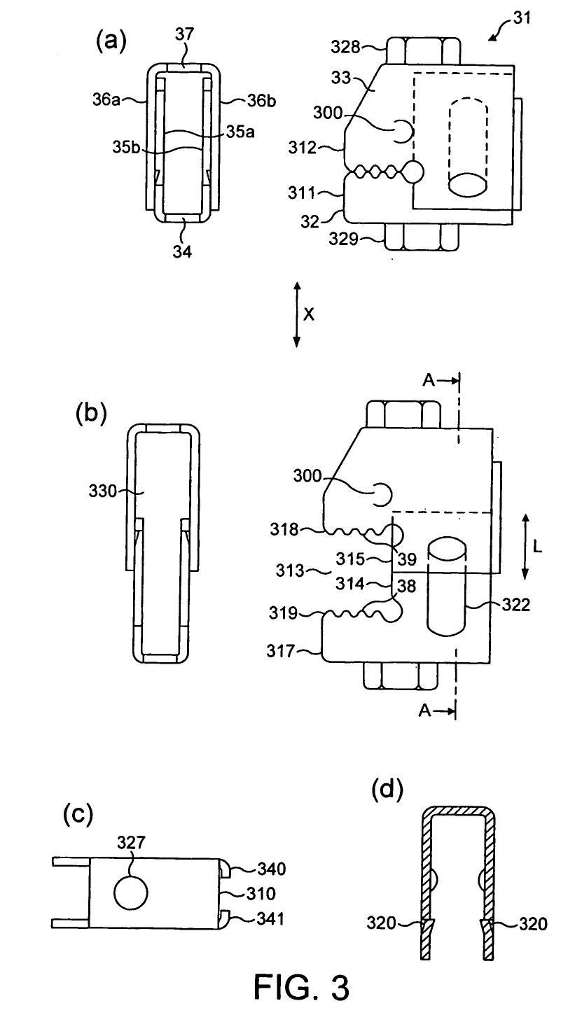

FIGS. 3a-c illustrates a second embodiment of the clamp of the invention at positions of (a) minimum separation of the jaws (side and end views) and (b) maximum separation of the jaws (side and end views) and in (c) top view and FIG. 3d illustrates an end view of the second jaw in isolation along section AA;

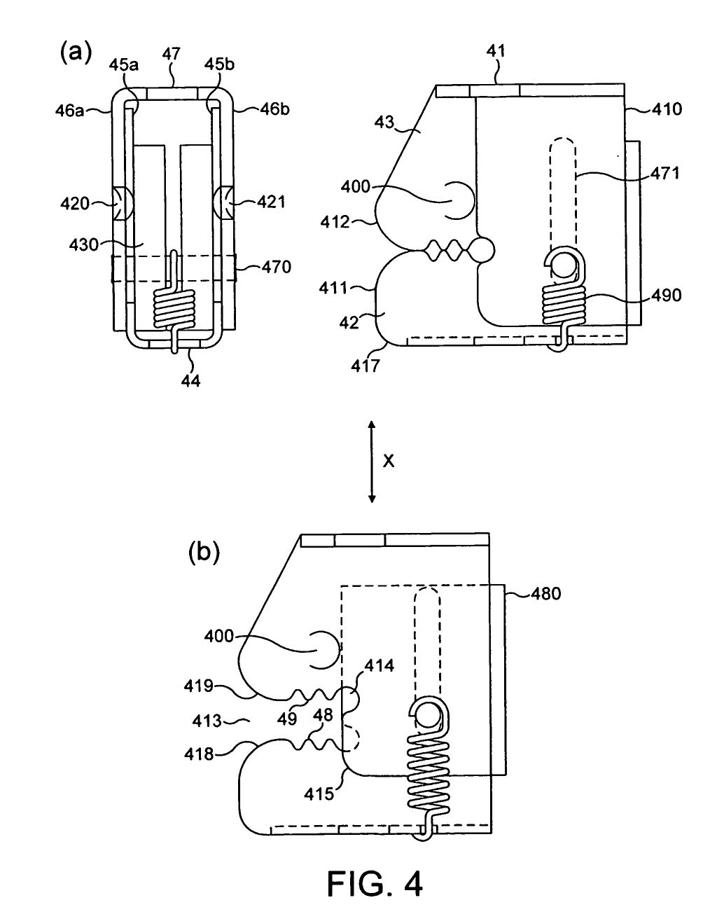

FIGS. 4a and 4b illustrate a third embodiment of the clamp of the invention at positions of minimum separation of the jaws (side and end views) and maximum separation of the jaws (side view); and

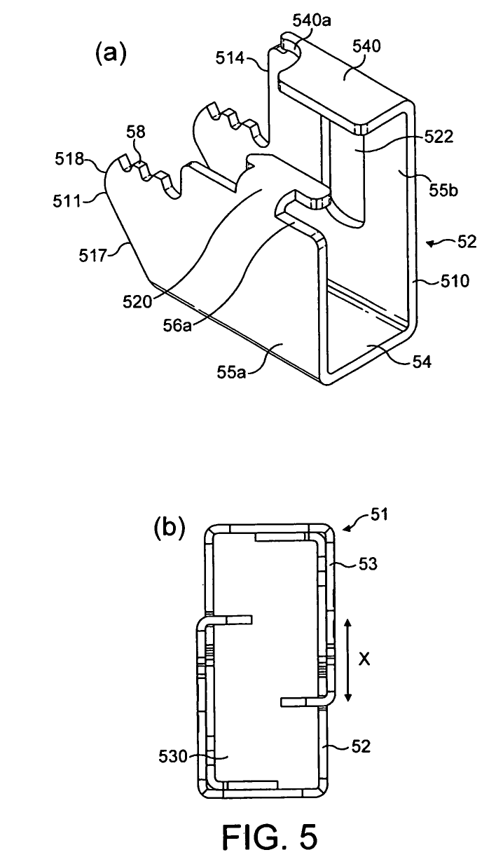

FIG. 5a illustrates one of the two identical jaws of a fourth embodiment of the clamp of the invention illustrated in FIG. 5b at a position of minimum separation of the jaws (side view).

A first embodiment of the clamp of the invention is illustrated in FIGS. 2a (closed-end and side view), 2b (open-end and side view) and 2c (top view) and is designated generally by reference numeral 1. The clamp 1 comprises a first jaw 2 in the form of a U-shaped body symmetrically nested partially within a second jaw 3 in the form of a U-shaped body. The U-shaped body of the first jaw 2 has a base 4 between opposed side walls 5a and 5b. The U-shaped body of the second jaw ˜3 has a base 7 between opposed side walls 6a and 6b and is generally of a larger overall dimension than the first jaw 2. The trailing edge 10 of the second jaw 3 and the trailing edge of the first jaw 2 bound an open rear end 30. The leading edge 11, 12 of the first and second jaw 2,3 respectively together define a mouth 13. The upper part of the leading edge 12 of the second jaw 3 is cut away into a nose portion. The lower part of the leading edge of the first jaw 2 is chamfered into a chin 17.

The first and second jaws 2,3 have opposing contact surfaces 8 and 9 respectively which in use contact lower and upper surfaces of a structural element such as a beam. The opposing contact surfaces 8 and 9 are relatively substantially linearly displaceable (ie in direction X) between a position of minimum separation (see FIG. 2a) and a position of maximum separation (see FIG. 2b).

The opposing contact surfaces 8 and 9 are provided with a plurality of n-shaped teeth which serve to grip the lower and upper surface of the structural element. An extended inner edge 14 and 15 of each of the opposing contact surfaces 8 and 9 respectively extend substantially parallel to the direction of linear displacement (X). An outer edge 18 and 19 of each of the opposing contact surfaces 8 and 9 respectively are radiussed.

In order to guide the opposing contact surfaces 8 and 9 during relative substantially linear displacement (and to prevent rocking), there are provided three guiding means:

(1) Tabs 20 and 21 inwardly dependent from the sides 6a and 6b of the second jaw 3 (seen most clearly in the isolated view of the second jaw 3 in FIG. 2d) slidably engage elongate apertures (only one of which is shown 22) in the first jaw 2 extending parallel to the direction of linear displacement X. The length 1 of the elongate aperture 22 delimits the linear displacement to the maximum separation illustrated in FIG. 2b;

(2) Elongate V-shaped depressions 23 and 24 in the second jaw 3 slidably engage corresponding elongate V-shaped depressions 25 and 26 in the first jaw 2; and

(3) Crescent shaped tabs (one of which only is shown as 200) inwardly dependent from the sides 6a and 6b of the second jaw 3 slidably engage extended inner edges 14 in the first jaw 2.

In use, the first and second jaws 2,3 may be opened manually to an extent sufficient to capture between the opposing contact surfaces the lower and upper surfaces of a structural element (eg to the position shown in FIG. 2a). Alternatively the radiussed outer edges 18 and 19 may be used as a camming surface to force open the first and second jaws 2, 3 by pressing the mouth 13 against the leading edge of the structural element. The clamp 1 may be steadied by bringing the leading edge of the structural element into contact with the extended inner edges 14, 15 of the first jaw 2 and second jaw 3. From this position, the first and second jaws 2,3 are closed so that the opposing contact surfaces contact the lower surface and upper surfaces of the structural element. During the opening and closing steps, the relative linear movement of the first and second jaws 2,3 is guided by the guiding means described above which also serve to resist relative non-linear displacement (eg rocking).

The second jaw 3 is provided with an aperture 27 collinear with an aperture in the first jaw 2 (not shown). Each aperture is capable of receiving a suspension element (not shown) such as a drop rod which may be fastened to the first jaw 2 using a nut 28 and to the second jaw 3 using a nut 29 in order to secure the clamp 1 to the structural element.

A second embodiment of the clamp of the invention is illustrated in FIGS. 3a (closed-end and side view), 3b (open-end and side view) and 3c (top view) and is designated generally by reference numeral 31. The clamp 31 comprises a first jaw 32 in the form of a U-shaped body symmetrically nested partially within a second jaw 33 in the form of a U-shaped body. The U-shaped body of the first jaw 32 has a base 34 between opposed side walls 35a and 35b. The U-shaped body of the second jaw 33 has a base 37 between opposed side walls 36a and 36b and is generally of a larger overall dimension than the first jaw 32. The trailing edge 310 of the second jaw 33 and the trailing edge of the first jaw 32 bound an open rear end 330. The leading edge 311, 312 of the first and second jaw 32,33 respectively together define a mouth 313. The upper part of the leading edge 312 of the second jaw 33 is cut away into a nose portion. The lower part of the leading edge of the first jaw 32 is chamfered into a chin 317.

The first and second jaws 32, 33 have opposing contact surfaces 38 and 39 respectively which in use contact lower and upper surfaces of a structural element such as a beam. The opposing contact surfaces 38 and 39 are relatively substantially linearly displaceable (ie in direction X) between a position of minimum separation (see FIG. 3a) and a position of maximum separation (see FIG. 3b).

The opposing contact surfaces 38 and 39 are provided with a plurality of n-shaped teeth which serve to grip the lower and upper surface of the structural element. An extended inner edge 314 and 315 of each of the opposing contact surfaces 38 and 39 respectively extend substantially parallel to the direction of linear displacement (X). An outer edge 318 and 319 of each of the opposing contact surfaces 38 and 39 respectively are radiussed.

In order to guide the opposing contact surfaces 38 and 39 during relative substantially linear displacement (and to prevent rocking), there are provided three guiding means:

(1) Tabs 320 and 321 inwardly dependent from the sides 36a and 36b of the second jaw 33 (seen most clearly in the isolated view of the second jaw 33 in FIG. 3d) slidably engage elongate apertures (only one of which is shown 322) in the first jaw 32 extending parallel to the direction of linear displacement X. The length 1 of the elongate aperture 322 delimits the linear displacement to the maximum separation illustrated in FIG. 3b;

(2) Twin parts 340, 341 of the trailing edge 310 of the second jaw 33 which fold over the trailing edge of the first jaw 32; and

(3) Crescent shaped tabs (one of which only is shown as 300) inwardly dependent from the sides 36a and 36b of the second jaw 33 slidably engage extended inner edges 314 in the first jaw 32.

In use, the first and second jaws 32,33 may be opened manually to an extent sufficient to capture between the opposing contact surfaces the lower and upper surfaces of a structural element (eg to the position shown in FIG. 3a). Alternatively the radiussed outer edges 318 and 319 may be used as a camming surface to force open the first and second jaws 32, 33 by pressing the mouth 313 against the leading edge of the structural element. The clamp 31 may be steadied by bringing the leading edge of the structural element into contact with the extended inner edges 314, 315 of the first jaw 32 and second jaw 33. From this position, the first and second jaws 32,33 are closed so that the opposing contact surfaces contact the lower surface and upper surfaces of the structural element. During the opening and closing steps, the relative linear movement of the first and second jaws 32,33 is guided by the guiding means described above which also serve to resist relative non-linear displacement (eg rocking).

The second jaw 33 is provided with an aperture 327 collinear with an aperture in the first jaw 32 (not shown). Each aperture is capable of receiving a suspension element (not shown) such as a drop rod which may be fastened to the first jaw 32 using a nut 328 and to the second jaw 33 using a nut 329 in order to secure the clamp 31 to the structural element.

A third embodiment of the clamp of the invention is illustrated in FIGS. 4a (closed-end and side view) and 4b (open-side view) and is designated generally by reference numeral 41. The clamp 41 comprises a first jaw 42 in the form of a U-shaped body symmetrically nested partially within a second jaw 43 in the form of a U-shaped body. The U-shaped body of the first jaw 42 has a base 44 between opposed side walls 45a and 45b. The U-shaped body of the second jaw 43 has a base 47 between opposed side walls 46a and 46b and is generally of a larger overall dimension than the first jaw 42. The trailing edge 410 of the second jaw 43 and the trailing edge of the first jaw 42 bound an open rear end 430. The leading edge 411, 412 of the first and second jaw 42,43 respectively together define a mouth 413. The upper part of the leading edge 412 of the second jaw 43 is cut away into a nose portion. The lower part of the leading edge 411 of the first jaw 42 is chamfered into a chin 417.

The first and second jaws 42, 43 have opposing contact surfaces 48 and 49 respectively which in use contact lower and upper surfaces of a structural element such as a beam. The opposing contact surfaces 48 and 49 are relatively substantially linearly displaceable (ie in direction X) between a position of minimum separation (see FIG. 4a) and a position of maximum separation (see FIG. 4b).

The opposing contact surfaces 48 and 49 are provided with a plurality of n-shaped teeth which serve to grip the lower and upper surface of the structural element. An extended inner edge 414 and 415 of each of the opposing contact surfaces 48 and 49 respectively extend substantially parallel to the direction of linear displacement (X). An outer edge 418 and 419 of each of the opposing contact surfaces 48 and 49 respectively are radiussed.

In order to guide the opposing contact surfaces 48 and 49 during relative substantially linear displacement (and to prevent rocking), there are provided four guiding means:

(1) Tabs 420 and 421 inwardly dependent from the sides 46a and 46b of the second jaw 43 slidably engage the extended inner edge 414 of the first jaw 42;

(2) A rivet 470 extends laterally between the sides 46a and 46b of the second jaw 43 and is fixed exteriorly thereto. The rivet 470 passes through collinear elongate apertures (only one of which is shown as 471) in the sides 45a and 45b of the first jaw 42;

(3) Twin parts (one or which only is shown as 480) of the trailing edge 410 of the second jaw 43 which fold over the trailing edge of the first jaw 42; and

(4) Crescent shaped tabs (one of which only is shown as 400) inwardly dependent from the sides 46a and 46b of the second jaw 43 slidably engage extended inner edges 414 in the first jaw 42.

In use, the first and second jaws 42,43 may be opened manually to an extent sufficient to capture between the opposing contact surfaces the lower and upper surfaces of a structural element (eg to the position shown in FIG. 4a). Alternatively the radiussed outer edges 418 and 419 may be used as a camming surface to force open the first and second jaws 42, 43 by pressing the mouth 413 against the leading edge of the structural element. The clamp 41 may be steadied by bringing the leading edge of the structural element into contact with the extended inner edges 414, 415 of the first jaw 42 and second jaw 43. From this position, the first and second jaws 42,43 are closed so that the opposing contact surfaces contact the lower surface and upper surfaces of the structural element. During the opening and closing steps, the relative linear movement of the first and second jaws 42,43 is guided by the guiding means described above which also serve to resist relative non-linear displacement (eg rocking) in a most effective manner.

The clamp 41 is biassed towards the closed position (FIG. 4a) by a spring 490 attached at one end to the rivet 470 and at the other to the base 44 of the first jaw 42. This assists snap fit assembly. The clamp 41 may be provided with apertures, fasteners and nuts as described previously.

A fourth embodiment of the clamp of the invention is illustrated in FIG. 5b (closed-end view) and is designated generally by reference numeral 51. The clamp 51 comprises a first jaw 52 illustrated in isolation in FIG. 5a in the form of a U-shaped body asymmetrically nested partially within a second jaw 53 which is identical in profile to the first jaw 52. The U-shaped body of the first jaw 52 has a base 54 between opposed side walls 55a and 55b containing an ellipsoidal aperture (not shown but collinear with the ellipsoidal aperture in the second jaw 53). Each aperture is capable of receiving a suspension element (not shown) such as a drop rod which may be fastened to the first jaw 52 using a nut and to the second jaw 53 using a nut in order to secure the clamp 1 to the structural element. The trailing edge 510 of the first jaw 52 and the trailing edge of the second jaw 53 bound an open rear end 530. The leading edge 511 of the first jaw 52 and of the second jaw 53 together define a mouth. The lower part of the leading edge 511 of the first jaw 52 is chamfered into a chin 517.

The first and second jaws 52, 53 have opposing contact surfaces 58 which in use contact lower and upper surfaces of a structural element such as a beam. The opposing contact surfaces 58 are relatively substantially linearly displaceable (ie in direction X) between a position of minimum separation (see FIG. 5b) and a position of maximum separation.

The opposing contact surfaces 58 are provided with a plurality of n-shaped teeth which serve to grip the lower and upper surface of the structural element. An extended inner edge 514 of each of the opposing contact surfaces 58 extends substantially parallel to the direction of linear displacement (X). The edge between the trailing edge 510 and the extended inner edge 514 extends inwardly into a flange 540 which is radiussed 540a. An outer edge 518 of each of the opposing contact surfaces 58 is radiussed.

In order to guide the opposing contact surfaces 58 during relative substantially linear displacement (and to prevent rocking), there is provided a guiding means:

(1) T-shaped tab 520 inwardly dependent from an edge 56a of the first jaw 52 between the trailing edge 510 and the extended inner edge 514 slidably engages an elongate slot 522 in the second jaw 53 extending parallel to the direction of linear displacement X.

In use, the opposing T-shaped tabs 520 and elongate slots 522 of the first jaw 52 and second jaw 53 respectively are hooked together and aligned to lock the T-shaped tabs 520 within the elongate slots 522. The length of the elongate slot 522 delimits the linear displacement to the maximum separation. The first and second jaws 52, 53 may be opened manually to an extent sufficient to capture between the opposing contact surfaces 58 the lower and upper surfaces of a structural element. Alternatively the radiussed outer edges 518 may be used as a camming surface to force open the first and second jaws 52, 53 by pressing the mouth 513 against the leading edge of the structural element. The clamp 51 may be steadied by bringing the leading edge of the structural element into contact with the extended inner edges 514 of the first jaw 52 and second jaw 53. From this position, the first and second jaws 52, 53 are closed so that the opposing contact surfaces 58 contact the lower surface and upper surfaces of the structural element. During the opening and closing steps, the relative linear movement of the first and second jaws 52, 53 is guided by the guiding means described above which also serve to resist relative non-linear displacement (eg rocking). This effect is enhanced by the fact that rocking causes the T-shaped tabs 520 and the flanges 540 (which are carefully positioned) to impinge on the suspension element or fastener so as to withstand the turning moment. The anti-rotation effect of the T-shaped tabs 520 and the flanges 540 increases as the jaws 52, 53 move apart linearly.

1. A clamp comprising:
a first jaw and a second jaw having opposing contact surfaces which are relatively substantially linearly displaceable between a position of minimum separation and a position of maximum separation, wherein in use the opposing contact surfaces contact the lower surface and upper surface respectively of a structural element, wherein the first jaw incorporates a first aperture remote from the contact surface and adapted to receive a suspension element or fastener;
one or more means for guiding the first jaw and the second jaw during relative substantially linear displacement such as to substantially prevent relative non-linear displacement of the opposing contact surfaces; and
means for delimiting the substantially linear displacement of the opposing contact surfaces of the first jaw and second jaw to the position of maximum separation.

2. A clamp as claimed in claim 1, wherein the first jaw comprises a first reentrant body and the second jaw comprises a second reentrant body.

3. A clamp as claimed in claim 2, wherein the first reentrant body is nested at least partially within the second reentrant body.

4. A clamp as claimed in claim 2, wherein the first reentrant body is symmetrically nested at least partially within the second reentrant body.

5. A clamp as claimed in claim 3, wherein the second reentrant body is deeper than the first reentrant body.

6. A clamp as claimed in claim 3, wherein the first reentrant body is composed of a material which is thinner than the material of which the second reentrant body is composed.

7. A clamp as claimed in claim 2, wherein the first reentrant body is asymmetrically nested at least partially within the second reentrant body.

8. A clamp as claimed in claim 2, wherein each reentrant body has a base between substantially parallel opposed side walls, a leading edge and a trailing edge.

9. A clamp as claimed in claim 2, wherein the contact surface of each reentrant body has an extended inner edge which in use abuts a surface of the structural element.

10. A clamp as claimed in claim 1, wherein the one or more of the means for guiding the first jaw and the second jaw during relative substantially linear displacement comprises:
male and female portions on the first jaw and second jaw slidably engageable in a direction parallel to the direction of linear displacement.

11. A clamp as claimed in claim 10, wherein the male and female portions comprise:
one or more elongate discontinuities extending parallel to the direction of linear displacement in the side of the second jaw slidably engageable with one or more elongate discontinuities extending parallel to the direction of linear displacement in the side of the first jaw.

12. A clamp as claimed in claim 10, wherein the clamp further comprises:
biassing means for biassing the first jaw and second jaw towards the position of minimum separation.

13. A clamp as claimed in claim 10, wherein the first jaw incorporates a first aperture rearwardly of the contact surface.

14. A claim as claimed in claim 13, wherein the second jaw incorporates a second aperture substantially collinear with the first aperture, and wherein the first and second aperture are adapted to received the suspension element or fastener.

15. A clamp as claims in claim 13, wherein the firs reentrant body is nested at least partially within the second reentrant body.

16. A claim as claimed in claim 15, wherein the second jaw incorporates a second aperture substantially collinear with the first aperture, and wherein the first and second aperture are adapted to received the suspension element or fastener.

17. A clamp as claimed in claim 16, wherein the first reentrant body is symmetrically nested at least partially within the second reentrant body.

18. A clamp as claimed in claim 16, wherein the first reentrant body is asymmetrically nested at least partially within the second reentrant body.
